(19) United States
(12) Patent Application Publication
(10) Pub. No.: US 2016/0097594 A1
(43) Pub. Date: Apr. 7, 2016

(54) REMELTING FURNACE WITH A WEIGHING CELL

(71) Applicant: ALD Vaccum Technologies GmbH, Hanau (DE)

(72) Inventors: Ivaylo POPOV, Hanau (DE); Ralf Oehler, Darmstadt (DE); Walter Nilius, Riegelsberg (DE)

(73) Assignee: ALD Vaccum Technologies GmbH, Hanau (DE)

(21) Appl. No.: 14/872,717

(22) Filed: Oct. 1, 2015

(30) Foreign Application Priority Data
Oct. 2, 2014 (DE) 10 2014 014 407.0

(51) Int. Cl. F27D 21/00; F27B 1/00; F27D 11/04

(52) U.S. Cl. CPC F27D 21/0035; F27D 11/04; F27B 1/00

(57) ABSTRACT

A remelting furnace is disclosed. An electrode rod drive with an electrode rod, as well as a retaining ring to retain a high-current cable, are arranged on a platform which is located on a weighing cell. Even though the position of the high-current cable changes during lowering of the electrode rod supporting a consumable electrode, the recorded weight portion of the high-current cable remains the same, which means that ultimately the change in the weight of the consumable electrode can be determined with the weighing cell.

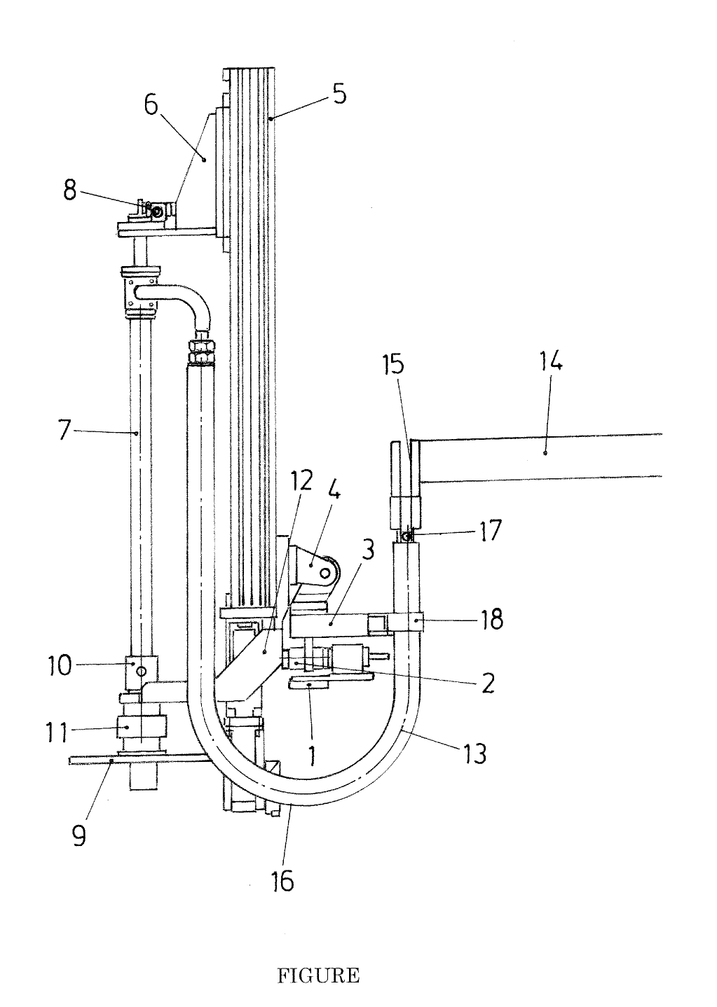

This application claims the priority of German Patent Application No. DE 10 2014 014 407.0, filed Oct. 2, 2014, the disclosure of which is expressly incorporated by reference herein.

### BACKGROUND AND SUMMARY OF THE INVENTION

The invention relates to a remelting furnace having at least one weighing cell, a mold arranged in a system frame, an electrode rod substantially vertical and arranged above the mold, at the end facing the mold of which a consumable electrode that can be melted can be fastened, an electrode rod holder, to which the electrode rod is suspended, an electrode rod drive for vertical shifting of the electrode rod holder, in order to position the consumable electrode into the mold according to its consumption, a water-cooled high-current cable, which is electrically connected to the electrode rod on one side and to a busbar on the other side and which is supported by a holder, where the high-current cable extends between the holder and the electrode rod in an arc.

Such a type of remelting furnace is described in EP 0 212 491 A2.

Remelting furnaces are used to produce steels having a high degree of purity. Various processes are used, each of which require a correspondingly designed remelting furnace. With the so-called vacuum electric arc furnaces, the remelting of the consumable electrode takes place in a vacuum; to this end, the mold is located in a vacuum-tight, closed boiler. The consumable electrode plunges into the mold. By creating electrical voltage between the consumable electrode and the mold, an electric arc with a high current strength occurs between the lower end of the consumable electrode and the melt forming in the mold, which gradually enables the consumable electrode to melt.

With the electroslag remelt process, the consumable electrode, e.g., made of steel, plunges into the slag bath of an open mold, which simultaneously functions as the electrical resistance. The consumable electrode melts in this case as well. As the melt passes through the slag, sulfur and nonmetallic inclusions are absorbed by the slag and subsequently deposited. The process occurs under atmospheric pressure and not in a vacuum. The steel solidifies under the slag in a copper mold.

In both cases, the weight of the consumable electrode must be continuously recorded during the melt in order to determine the so-called melting rate. With the awareness of this melting rate, the lowering of the consumable electrode is regulated such that, with the vacuum electric arc furnace, there is always distance between the melting and the consumable electrode that guarantees the formation of an electric arc, while the electroslag remelt process ensures that the consumable electrode always remains immersed in the slag.

In the aforementioned EP 0 212 491 A2, one or more weighing cells are arranged between the electrode rod holder and the electrode rod, such that the weight of the electrode rod and the respective residual weight of the consumable electrode can be directly determined.

The water-cooled high-current cable, however, connects directly to the electrode rod so that its weight can also be recorded. As the electrode rod is lowered however, the proportional weight of the high-current cable changes, which means that the melting rate cannot be clearly determined.

It has already been proposed to incorporate a frame, within which the electrode rod is located and which is supported via a plurality of weighing cells, which are evenly distributed on the periphery of the frame, opposite the furnace frame or the cover of the boiler of a vacuum electric arc furnace.

In order to achieve a high degree of measuring accuracy, a large amount of structural work is thus necessary; in addition, a certain structural height is required.

The object of the invention is to obtain a compact arrangement with which the respective current weight of the consumable electrode can be determined.

In order to attain the object, the invention specifies that the high-current cable be tightly connected to the holder such that the at least one weighing cell is mounted on the system frame and a platform is supported, in which the electrode rod drive and the holder for the high-current cable are arranged on the platform.

The platform thus supports all essential parts and particularly also the high-current cable such that the weight change of the totality of all parts that are supported on the weighing cell by means of the platform is determined solely by the change in the weight of the consumable electrode.

Because the high-current cable extends in an arc from the holder up to the connection at the electrode rod, the weight of the entire arc is recorded by the weighing cell, regardless of how far it has been lowered with the electrode rod.

In order to achieve the maximum possible uniform weight distribution on the weighing cell, a provision is that the electrode rod drive be a vertically aligned linear drive, that the electrode rod extends parallel thereto, and that the electrode rod and the holder be arranged on opposite sides of the linear drive.

Particularly with vacuum electric arc furnaces in which the mold is located in a vacuum furnace boiler, the electrode rod is guided through a feed-through in the furnace boiler cover, which is located above the mold, and the feed-through is supported by the platform.

In order to maintain the vacuum, the feed-through is routed around the electrode rod precisely, such that friction forces inevitably occur here. In order to prevent this from having effects on the measurement, a provision is for the feed-through to be supported by the platform.

The feed-through itself is located above an opening in a furnace boiler, which accommodates the mold. Bellows are located between the feed-through and the furnace boiler cover. Even though the bellows lead to weight relief for the feed-through because their pre-tension remains constant even during lowering of the electrode rod, their influence can be ignored.

Preferably it is provided for the holder for the high-current cable to be formed by a retaining ring fastened to the platform, with the retaining ring tightly surrounding the high-current cable. This ensures that only the weight portion of the section of the high-current cable that extends in an arc to the electrode rod is recorded by the weighing cell; the area above the retaining ring from the connection of the high-current cable to the busbar, however, is supported by the busbar and thus is not considered during the weight determination.

Any potential disturbing influences during the measurement are particularly small when the retaining ring is located as precisely as possible underneath the connection of the high-current cable at the busbar.

Preferably, the electrode rod drive and the through-feed are retained on the platform by means of an adjustable pivoting joint.

The invention is explained in more detail in the following by means of an exemplary embodiment. To that end, the single FIGURE is a schematic representation of the invention.

### BRIEF DESCRIPTION OF THE DRAWING

The FIGURE provides a schematic representation of the remelting furnace with a weighing cell of the present invention.

### DETAILED DESCRIPTION OF THE DRAWING

Only one single weighing cell 2, on which a platform 3 is arranged, is located on the system frame 1, which is only alluded to here.

A pivoting joint 4, to which an electrode rod drive 5 in the form of a vertically aligned linear drive 5 is fastened, is positioned on the platform 3. The pivoting joint 4 makes it possible to align the electrode rod drive 5 precisely vertically. An electrode rod holder 6, which can be vertically moved by the linear drive and to which an electrode rod 7 is attached so as to be suspended, is positioned at the upper end of the electrode rod drive 5. An adjusting mechanism 8 is located at the electrode rod holder 6 in order to vertically align the electrode rod 7.

The furnace boiler 9, which is also represented here only in the upper part, contains an opening, through which the electrode rod 7 is routed, in which a through-feed 10 in the form of a sleeve above the furnace boiler is located, with the electrode rod being routed through the sleeve with as little play as possible.

The through-feed 10 is positioned on bellows 11 fastened on the furnace boiler 9 and is connected to the bellows.

The through-feed 10 is connected to the platform 3 via a bracket 12 and is thus incorporated into the weight determination.

A consumable electrode, which is not shown in greater detail, is fastened here at the lower end of the electrode rod 7. The feed line of an electric current to the consumable electrode is implemented via a water-cooled high-current cable 13, one end of which is connected at the upper end of the electrode rod 7 and the other end of which is connected to a busbar 14. The high-current cable 13 includes a strand 15 which is encompassed by a shell 16, in which water is introduced for cooling the current-conducting strand 15 via a water connection 17.

The high-current cable 13 is fastened to the platform 3 by means of a retaining ring 18 which surrounds the high-current cable 13 underneath its connection to the busbar 14 and thus tightly retains it such that the high-current cable 13 cannot move opposite the retaining ring 18. Starting from this fastening at the platform 3, the high-current cable 13 is routed in an arc to the connection at the electrode rod 7. The water connection 17 is located between the retaining ring 18 and the connection of the high-current cable 13 to the busbar 14.

In order to achieve central loading of the weighing cell 2, the electrode rod 7 and the retaining ring 18 for the high-current cable 13 are located on opposite sides of the electrode rod drive 5.

The FIGURE shows the controlling mechanism for the consumable electrode in a state in which it is at its highest point. Because the consumable electrode is melted gradually, it must be lowered into the mold in a controlled manner. This occurs with the assistance of the electrode rod drive 5, in which the regulation of the lowering path takes place in a weight-controlled manner. The weighing cell 2 thus records the weight of the electrode rod drive 5, the electrode rod 7, the feed-through 10, and the section of the high-current cable 13, from the connection to the electrode rod 7 up to the retaining ring 18. The weight of the busbar 14 and of the water connection 17 are not recorded, because they are positioned above the retaining ring 18. The recorded weight portion of the high-current cable 13 is constant, because it does not depend on how far the arc, which the current cable passes through, is lowered downward along with the electrode rod 7.

Because the aforementioned components always have the same weight, except for the consumable electrode, the weight of the consumable electrode can be determined with the weighing cell 2, and the electrode rod drive 5 can be actuated accordingly.

### LIST OF REFERENCE CHARACTERS

1 System frame

2 Weighing cell

3 Platform

4 Pivoting joint

5 Electrode rod drive

6 Electrode rod holder

7 Electrode rod

8 Adjusting mechanism

9 Furnace boiler

10 Feed-through

11 Bellows

12 Bracket

13 High-current cable

14 Busbar

15 Strand

16 Shell

17 Water connection

18 Retaining ring

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A remelting furnace, comprising:
a system frame;
a weighing cell, wherein the weighing cell is mounted on the system frame and wherein the weighing cell supports a platform;
a mold arranged in the system frame;
an electrode rod extending substantially vertically and arranged above the mold, wherein a consumable electrode that is meltable is fastenable at a first end of the electrode rod facing the mold;
an electrode rod holder, wherein the electrode rod is suspended from the electrode rod holder;
an electrode rod drive, wherein the electrode rod holder is vertically shiftable by the electrode rod drive such that the consumable electrode is positionable into the mold according to a consumption of the consumable electrode; and
a high-current cable, wherein the high-current cable is electrically connected to the electrode rod on a first end and to a bulbar on a second end, wherein the high-current cable is tightly connected to a holder, and wherein the high-current cable extends between the holder and the electrode rod in an arc;
wherein the electrode rod drive and the holder are disposed on the platform.

2. The remelting furnace according to claim 1, wherein the electrode rod drive is a vertically aligned linear drive, wherein the electrode rod extends parallel to the electrode rod drive, and wherein the electrode rod and the holder are arranged on opposite sides of the electrode rod drive.

3. The remelting furnace according to claim 1, wherein the electrode rod is routed through a through-feed which is located above the mold and wherein the through-feed is supported by the platform.

4. The remelting furnace according to claim 3, wherein the mold is arranged in a furnace boiler, wherein the through-feed is located above an opening in the furnace boiler, and wherein a bellows is positioned between the furnace boiler and the through-feed.

5. The remelting furnace according to claim 1, wherein the holder is a retaining ring that is fastened to the platform and wherein the retaining ring tightly surrounds the high-current cable.

6. The remelting furnace according to claim 5, wherein the retaining ring is disposed underneath a connection of the high-current cable to the busbar.

7. The remelting furnace according to claim 3, wherein the electrode rod drive and the through-feed are retained on the platform by an adjustable pivoting joint.
